(19) United States
(12) Patent Application Publication
(10) Pub. No.: US 2010/0012712 A1
(43) Pub. Date: Jan. 21, 2010

(54) PAPER CUP MANUFACTURE WITH MICROENCAPSULATED ADHESIVE

(75) Inventors: Dean P. Swoboda, DePere, WI (US); Timothy L. Van Eyck, Appleton, WI (US)

Correspondence Address: Georgia-Pacific LLC, 133 Peachtree Street NE - GA030-41, ATLANTA, GA, 30303, US

(73) Assignee: DIXIE CONSUMER PRODUCTS LLC, Atlanta, GA (US)

(21) Appl. No.: 12/506,814

(22) Filed: Jul. 21, 2009

Related U.S. Application Data
(60) Provisional application No. 61/135,450, filed on Jul. 21, 2008.

(51) Int. Cl. B65D 3/06; B31B 1/62; B65D 5/12

(52) U.S. Cl. 229/400; 493/128; 493/131; 493/152; 229/4.5; 229/5.85

(57) ABSTRACT

Paper cup manufacture utilizing microencapsulated adhesive typically includes: (a) supplying a paperboard web to a coating line; (b) coating the web in the coating line with a liquid-resistant coating in a first predetermined pattern on a first side thereof corresponding to interior surfaces of sidewalls of paperboard cups formed from the paperboard blanks; (c) coating the web in the coating line with a microencapsulated adhesive in a second predetermined pattern corresponding to seams of paperboard cups formed from the paperboard blanks, the microencapsulated adhesive thereby being applied in common registry with the liquid-resistant coating in the coating line; and (d) cutting paperboard blanks from the web. The paperboard blanks are then (e) formed into the cup sidewall with the adhesive securing a seam.

### CLAIM FOR PRIORITY

This application is based upon U.S. Provisional Application No. 61/135,450 of the same title, filed Jul. 21, 2008. The priority of Application No. 61/135,450 is hereby claimed and the disclosure of which is incorporated by reference into this application.

### FIELD OF INVENTION

This case relates to paper cup manufacture, using a paperboard blank cut from a web which is provided with a wax coating and microencapsulated adhesive applied in registry. The web is cut into blanks and a sidewall seam is secured by the microencapsulated adhesive, making separate glue application unnecessary and providing a superior sidewall seal.

### BACKGROUND OF THE INVENTION

The manufacture of paper cups from paperboard blanks is well known in the art. A typical manufacturing process for 3 oz. bath cups includes flexographic in-line printing and waxing on opposite board sides followed by slitting into cup machine usable rolls. On the cup machine, the board is blanked, liquid glue is then applied on one edge of the waxed side of the blank, and the blank is wrapped around a forming mandrel. A side seam clamp is applied to the cone where the opposite edges of the wrapped blank overlap approximately ¼″ and the seam is thus secured. See U.S. Pat. No. 4,452,596 to Clauss et al., the disclosure of which is incorporated herein by reference.

U.S. Pat. No. 4,386,576 to Johnson discloses a glue applicator for a machine making two-piece paper cups, i.e. with a separate bottom panel. See also U.S. Pat. No. 6,200,406 to Ito which teaches applying a sealing agent either immediately before or after cutting a cup blank. Paper cup manufacture as well as the disclosure of the foregoing patents is perhaps better understood by reference to FIG. 1, adapted from the disclosure of Johnson '576. Prior to being supplied to a cup machine, a paperboard web is wound through a printing/coating line with ink forming a decorative pattern on one side of the board, and wax applied to the other side of the board as noted above. The board is slit, wound out, and sidewall paperboard blanks 10 are cut from the board. A strip of liquid glue is applied to each blank on an unwaxed edge side-seam 12, which is approximately 3/16″ wide, as well as to a wax tab at the bottom of the side-seam. Each blank is inserted in clips, or grippers, 14 which transfer the blank through stations 16, 18, 20 and 22. The blank is then wound onto a mandrel cone 24 such that the glued side-seam contacts the outside opposite edge of the blank. A side seam clamp, or pressure bar, 26 applies pressure to the overlapping edges to seal the sidewall seam of the cup. The bottom 28 of the cup is heat sealed to a lower portion of the blank 30 using a thermoplastic polymer by generally conventional methods. The cup may further be treated with wax by spray coating or other means, as disclosed by U.S. Pat. No. 6,379,497 to Sandstrom et al. See FIG. 36A thereof.

Conventional processing has numerous drawbacks. Separate steps of printing and waxing, blank cutting and liquid glue application create the potential for misalignment at each station of processing. Blanks may become skewed from their intended position as they are transferred through the system. Liquid glue is frequently applied imprecisely, resulting in transfer from the paper to the mandrels after clamping. Glue wheels sometimes cause glue skips if the glue does not transfer to the blank properly, which results in cup leaks. Even under ideal conditions, the glue application system consists of many parts that require maintenance and frequent cleaning. In addition, glue build-up on the clamps and forming mandrels also requires frequent cleaning, even when misalignment of the blanks is not severe.

Conventional liquid glue has very restrictive viscosity requirements for proper processing. The viscosity and performance of liquid glue changes depending on the ambient temperature and seasonal humidity conditions. As these conditions vary, application of the glue is exceedingly difficult to control; the glue may ooze past the intended application area. Accordingly, the application protocols for applying liquid glue are necessarily conservative, making it impractical to apply the glue too closely along the wax line of a blank (which is preferred for leak resistance) because of tolerance considerations; that is, if a glue strip is positioned such that some glue is visible on the outer wall of a formed cup after forming, the result is unsightly; or if a glue strip is positioned such that some glue overlaps the wax line, the glue may not adhere properly. Even when the gluing process is closely monitored, the glue box can unexpectedly plug, resulting in downtime and unusable product.

Moreover, conventional liquid glue used in paper cup manufacture is water-soluble, otherwise solvents would need to be used to clean equipment, which is undesirable because of safety and environmental concerns. Water-soluble glue offers more limited liquid resistance in a cup designed to hold beverages than does a water-insoluble adhesive.

Manufacture of paper cups is vastly improved in accordance with the present invention through the use of microencapsulated adhesives as described hereinafter.

### SUMMARY OF THE INVENTION

There is provided in accordance with the present invention paper cup manufacture utilizing a paperboard blank for forming a sidewall of a paper cup having a paperboard substrate with an interior portion corresponding to the inner surface of the sidewall of the formed cup and a seam portion corresponding to a sidewall seam area of the formed cup. The seam portion of the blank is provided with a rupturable, microencapsulated adhesive composition in a non-adhesive state suitable for securing the sidewall seam upon rupture of microcapsules of the composition and activation of the adhesive. Preferably, the microencapsulated adhesive is applied in registration with a water resistant coating such as a wax coating, and/or in registration with a printed pattern. The cup may be formed in a conical shape, or optionally the paper cup is formed with a separate bottom panel. Among the advantages are: (1) adhesive application in registration with a wax coating and optionally with decorative printing for more precise relative positioning, allowing for adhesive application consistently adjacent to the wax coating line for improved sealing; (2) elimination of glue application after blanking, reducing process steps and necessary maintenance and equipment such as a glue box assembly used in conventional manufacture; (3) improved reliability, reducing glue skips commonly caused by a glue wheel; (4) significant reduction of glue deposit build-up on forming mandrels; and (5) the ability to apply more adhesive and different types of adhesives, for example non-water-soluble adhesives or combinations of different adhesives.

Other aspects and advantages of the present invention are described in the detailed description below and in the claims.

### BRIEF DESCRIPTION OF THE DRAWINGS

The invention is described in detail below with reference to the appended drawings, wherein like numerals designate similar parts. In the Figures:

FIG. 1 is a partial top perspective view of the portion of a conventional cup machine for manufacturing paper cups that incorporates liquid glue applicators;

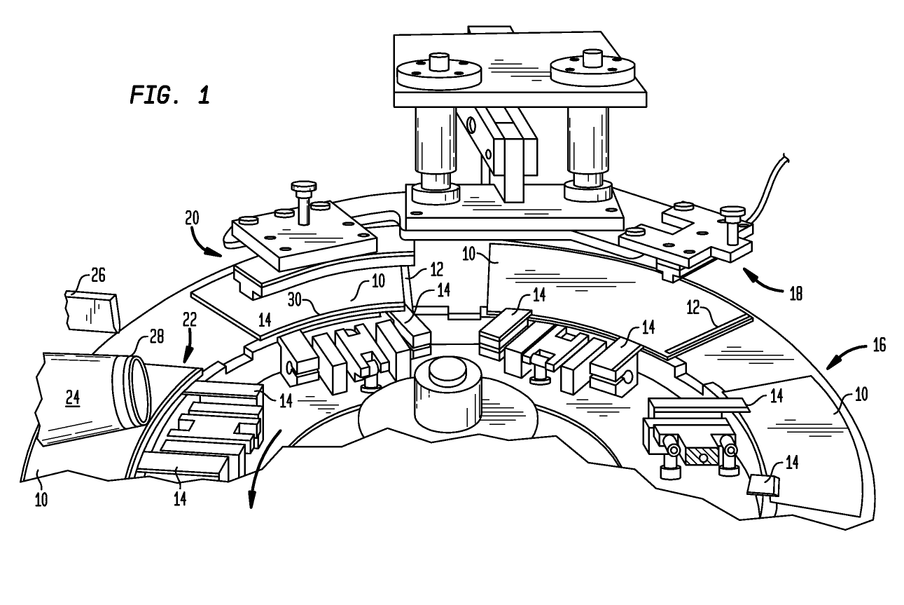

FIG. 2 is a photomicrograph (640×) of an aqueous dispersion of microencapsulated adhesive useful for practicing the present invention.

FIG. 3 is a partially cut away front perspective view of one embodiment of a paper cup having a sidewall seam secured with microencapsulated adhesive;

FIG. 4A is a plan view of a paperboard blank for forming a sidewall of a cup;

FIG. 4B is a plan view of another paperboard blank for forming a sidewall of a cup;

FIG. 4C is a plan view of the outside of the paperboard blank of FIG. 4B; and

FIG. 5 is a process flow diagram illustrating cup manufacture according to this invention.

### DETAILED DESCRIPTION OF THE INVENTION

The invention is described in detail below with reference to different embodiments and numerous adhesive materials. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

Two or more coatings are applied to a web in “common registry” when the web is fixed in a processing path such that the coatings may be applied in predetermined relative positions to one another on the web without re-positioning the web.

A “substantially continuous liquid proof seal over the length of the cup seam” has its ordinary meaning and additionally refers to a cup sidewall seam which will not leak for at least 10 minutes when the cup is filled with water at 50° C., or will not leak for at least five minutes when filled with a 25% alcohol aqueous solution of the class used for mouthwash.

“Decorative patterns” and like terminology refers generally to ink-printed patterns for aesthetics; however, such features may have a functional aspect such as indicating a fill line.

A “liquid resistant coating” means a wax coating or any coating or sizing operable to impart elevated water resistance to paper. Such coatings are generally much more hydrophobic than cellulose fiber.

As used herein, the term water-soluble glue refers to an adhesive agent soluble or dispersible in water as a carrier, and which will re-disperse in water after it is dried. Water-soluble glues include, for example, polyvinyl acetate homopolymer or copolymer based emulsions, acrylic emulsions, casein formulations, dextrine/starch-based adhesives, and natural rubber latex. Of these, a polyvinyl acetate homopolymer or copolymer emulsion-based adhesive is sometimes preferred. Examples of a water insoluble adhesive, on the other hand, include alkyl methacrylate based compositions and compositions based on similar prepolymers; as well as compositions based on water insoluble block co-polymers/synthetic rubbers; latexes which do not re-disperse in water and so forth.

The terminology “microencapsulated adhesive”, “microencapsulated adhesive composition” and the like refers to adhesive compositions which include a microencapsulated component contained within capsule walls which, upon rupture of the microcapsules, releases the adhesive of the composition so that it will seal a cup seam provided the adhesive is activated. The capsules are microspheres of a size generally ranging from 0.25 to about 1000 μm, preferably from 1 or 2 μm, perhaps a minimum of 5 μm in some cases up to a maximum of 200 μm in some embodiments as is further discussed herein. Microencapsulated adhesives are known in the art and are often conveniently classified based upon mode of activation, extent of component microencapsulation, adhesive chemistry, and so forth. See U.S. Pat. No. 6,592,990 to Schwantes, the disclosure of which is incorporated herein by reference.

### Pressure and Solvent-Sensitive Microencapsulated Adhesives

One preferred class of adhesives which are utilized in connection with the present invention are referred to herein as pressure and solvent-sensitive microencapsulated adhesives. These adhesives are inactive until both pressure and solvent (typically water) are applied to the adhesive system in order to rupture the microcapsules and activate the liberated adhesive. Thus, “a pressure and solvent-sensitive adhesive composition” and like terminology refers to a “dual trigger” system requiring pressure to rupture the microcapsules and solvent to activate the adhesive. It is accordingly more unlikely than in single “trigger” systems that the adhesive will inadvertently be activated and ruin rolled product since both sufficient pressure and moisture are needed to activate the adhesive so that interlayer bonding occurs. So also, the adhesive is only activated in the desired areas during cup formation to prevent activating adhesive in unwanted areas of the cups. An additional benefit is that available water in and on the paperboard “finds” the hygroscopic adhesive, activating the adhesive in a microscale which provides superior bonding of the cup seam.

Suitable adhesives, such as Adhesive No. 7246, available from Microtek Laboratories, Dayton, Ohio may be employed. This adhesive is a pressure and water-sensitive, microencapsulated polyvinyl acetate adhesive, wherein the polyvinyl acetate adhesive is in a dry, inactive state. That is, the membrane encapsulates the polyvinyl acetate and maintains it in a relatively dry state, even after the composition is dispersed in water and immobilized on the substrate. The polyvinyl acetate adhesive core material used is PA3053MDRNC (H. B. Fuller). Microencapsulated adhesive may include about 90% by weight adhesive and about 10% by weight membrane material, the microspheres having an average size (diameter) of about 10 microns or so in some cases.

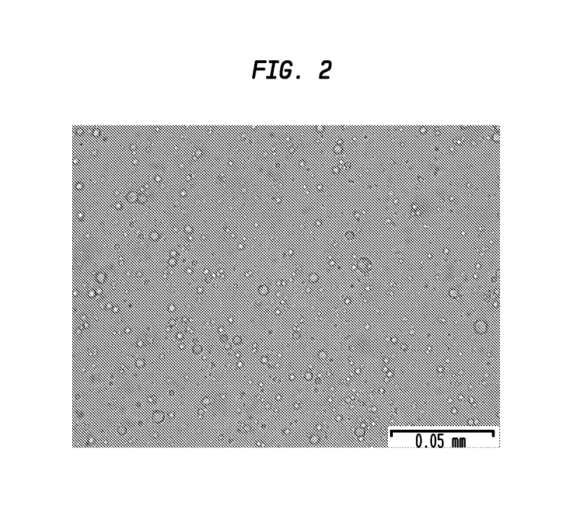

FIG. 2 is a photomicrograph of an aqueous dispersion of Adhesive No. 7246 wherein it can be seen the adhesive is well-dispersed and suitable for flexographic printing and wherein the particle size of the composition is appreciated from the legend provided.

Suitable adhesives may be produced by way of the techniques described in U.S. Pat. No. 5,911,923 to Work et al., entitled “Method for Microencapsulating Water-Soluble or Water-Dispersible or Water-Sensitive Materials in an Organic Continuous Phase”, the disclosure of which is hereby incorporated by reference. In addition, techniques enumerated in the following patents, also incorporated herein by reference, may also be used if so desired: U.S. Pat. No. 7,550,200 to Hart et al., entitled “Microencapsulation of Biocides and Antifouling Agents”; U.S. Pat. No. 6,835,334 to Davis et al., entitled “Macrocapsules Containing Microencapsulated Phase Change Materials”; U.S. Pat. No. 6,703,127 to Davis et al., entitled “Macrocapsules Containing Microencapsulated Phase Change Materials”; and U.S. Pat. No. 5,435,376 to Hart et al., entitled “Flame Resistant Microencapsulated Phase Change Materials”.

Preferably, the encapsulating membrane of polymer or other material is FDA-approved for food contact and contains a water-sensitive adhesive such as a polyvinyl acetate adhesive. The microencapsulated adhesive is dispersed in water and the aqueous dispersion is printed onto the desired area of the cup blank stock. When the cup is formed, a seal area opposite the wall area of the blank to which microencapsulated adhesive has been applied is wetted with water. When the cup is clamped to seal the seams, membranes encapsulating the adhesive rupture and the separately provided water in the opposite surface activates the dry adhesive. This provides a control benefit in that the adhesive is only activated in connection with the opposite wetted seal area since the dry adhesive does not bond, as discussed above.

Without intending to be bound by any theory, it is believed that the membrane material suitably encapsulates a moisture or solvent-sensitive adhesive and maintains it in a relatively dry state. Even when the microencapsulated adhesive is dispersed in aqueous media, the hydrophobic membrane keeps the encapsulated adhesive relatively dry and in an inactive state when released from the membrane. Further details are discussed hereinafter in connection with cup formation and specific embodiments of the present invention.

### Microencapsulated Adhesives Generally

A microencapsulated adhesive is in a “non-adhesive state” or is inactive prior to being activated by rupturing the microcapsules of the composition, and optionally adding water or other solvents in the case of pressure and solvent sensitive systems. While in a non-adhesive state, the microencapsulated adhesive will not adhere adjacent layers in a paperboard roll, for example, so that a roll with a printed pattern of microencapsulated adhesive can be rolled and unrolled without generating fiber tear. The microencapsulated adhesive is “activated” when enough microcapsules are ruptured and optionally an activating agent is added to render the adhesive tacky enough to adhere one paperboard layer to another, preferably generating fiber tear strength. Hot melt adhesives which are not microencapsulated can react similarly to temperature if applied below their activation temperature and subsequently heated and pressed to seal a seam.

Microencapsulated adhesives may in some cases include liquid glues (liquid at room temperature) that are encapsulated in various ways, for example, a liquid glue may be encapsulated by interfacial polymerization, gelatin/gum arabic coacervation or melamine/formaldehyde encapsulation as is described, for example in U.S. Pat. Nos. 5,919,407 and 5,709,340 to Chao, the disclosures of which are incorporated herein by reference. So also, microencapsulated adhesive compositions include adhesive systems where a solvent is encapsulated or reactive and curable resin systems. Solvent-based systems rely on adhesive reactivation through solvent delivery. Microcapsules are used as the vehicle to retain the solvent until needed. Other activatable systems rely on a plasticizer or UV initiator being encapsulated in place of solvent in order to tackify the resin at the time of use. Reactive resin systems typically involve an encapsulated curing system. Either the total formulation or one component can be encapsulated. The reactive components however must be isolated or kept separate until use. Typically two separate encapsulations are required. Reactive systems may employ epoxy resins, isocyanates, polyesters and the like.

One specific class of encapsulated adhesive is referred to as “self-contained capsules”. Typically a curing agent is adhered to the capsule surface. Upon rupture of the capsule wall, the resin flows to contact the curing agent. Curing agents can include boron trifluoride complexes, nitrile or aniline type catalysts, acid chlorides, hexamethylenetetramine, various oxides, dibutyltin dilaurate and the like.

Further details concerning various microencapsulated adhesives are known in the art, as can be seen in, for example, U.S. Pat. No. 4,536,524 to Hart et al., U.S. Pat. No. 5,919,557 to Lorenz et al., U.S. Pat. No. 6,084,010 to Baetzold et al., U.S. Pat. No. 6,004,417 to Roesch et al., and U.S. Pat. No. 5,532,293 to Landis, all of which are incorporated herein by reference. Some examples of microencapsulated adhesive compositions include: a cohesive, such as a rubber latex, coupled with a solvent, such as an alkyl biphenylaliphatic hydrocarbon mix; or one could prepare microencapsulated adhesives by known methods based on conventional adhesives such as natural gums and resins; animal glues; elastomers; polyvinyl acetate; reactive adhesives; and so forth. Additional components may be included in the adhesive composition, such as modifiers, rheology aids, tackifiers, rubberized particles, lubricants and plasticizers, binders and the like.

Suitable capsule or shell materials include a number of natural or synthetic materials, but must be resistant to the pressure associated with rolling and cutting paperboard, and compatible with the selected adhesive system and whatever carrier and other components are used. See also, the disclosure of U.S. Pat. No. 5,271,881 to Redding, Jr. (particularly col. 7, Table 3), which is incorporated herein by reference. However, other materials may be used, such as a melamine-formaldehyde resin or other waxes or block copolymers than shown in Redding, Jr. The microcapsule shell is formed from hydrophilic materials comprising gellable colloids, carboxymethyl cellulose, gelatin, gelatin-gum arabic, methylated methylol melamine resin, melamine formaldehyde, dimethylol urea, urea formaldehyde, methylol melamine, methylated dimethyl urea, a gelatin anionic polymer, alkyl acrylate-acrylic acid copolymer or other polymeric materials used in coacervation. The shell wall thickness is especially preferably as thin as possible while retaining enough durability to prevent premature release of the adhesive. U.S. Pat. No. 7,300,530 to Bouchette et al. describes microencapsulated adhesive compositions, wherein the microcapsules range in diameter from about 1 micron to about 100 microns. The diameter and wall thickness are controlled by adjusting the amount of mixing energy applied to the materials immediately before wall formation. The wall material described in Bouchette et al may be a polyacrylate material, gelatin capsule, or gel-coated capsule. Preparation of the microcapsules may be by interfacial polymerization, phase separation processes, or coacervation processes, and may involve polymerization of urea and formaldehyde, monomeric or low molecular weight polymers of dimethylol urea or methylated dimethylol urea, melamine and formaldehyde, monomeric or low molecular weight polymers of methylol melamine or methylated methyl melamine. Microencapsulation methods may include reaction in an aqueous vehicle conducted in the presence of negatively-charged, carboxyl-substituted, linear aliphatic hydrocarbon polyelectrolyte material dissolved in the vehicle, or reaction in the presence of gum arabic, or reaction in the presence of an anionic polyelectrolyte and an ammonium salt of an acid. The disclosure of the '530 patent is hereby incorporated by reference.

As one of skill in the art will appreciate, microencapsulated adhesive compositions may be made from a plethora of materials by many methods. For example, U.S. Pat. No. 7,323,039 to Suzuki et al. teaches emulsion methods for preparing core/shell microspheres using an in-water drying method, after which the microspheres are recovered from the emulsion by centrifuging, filtering, or screening. U.S. Pat. No. 7,286,279 to Yu describes microencapsulation processes and compositions prepared in a solution comprising a polymer precursor such as a monomer, chain extender, or oligomer; emulsifying the precursor into a fluorinated solvent; and forming microparticles by hardening the emulsion by polymerization/crosslinking the precursor, including interfacial and/or in-situ polymerization/crosslinking. U.S. Pat. No. 7,376,344 to Manne teaches heat sensitive encapsulation. U.S. Pat. No. 7,344,705 to Unger teaches preparation of low density microspheres using a heat expansion process wherein the microspheres are composed of biocompatible synthetic polymers or copolymers as described at col. 2, line 47—col. 3, line 9. Additional patents of interest for preparing microencapsulated adhesives may include U.S. Pat. No. 7,309,500 to Kim et al. U.S. Pat. No. '500 to Kim et al. discloses a method of forming microparticles wherein charging droplets of chitosan, gelatin, hydrophilic polymers such as polyvinyl alcohol (as discussed at col. 5, lines 39-57), proteins, peptides, or other materials (col. 6, lines 21 to col. 7, line 15 and 22-30) in an immiscible solvent to prevent them from coalescing before hardening, optionally treating the gelated microparticles with a cross-linking agent to modify their mechanical properties. See also U.S. Pat. No. 7,368,130 to Kim et al. U.S. Pat. No. 7,374,782 to Brown teaches production of microspheres of a macromolecule such as protein mixed with a water-soluble polymer under conditions which permit the water-soluble polymer to remove water from the protein in contact with a hydrophobic surface. U.S. Pat. No. 7,297,404 to Bayless describes coacervative microencapsulation, which is followed by phase separation and cross-linking. U.S. Pat. No. 7,375,070 to Pegelow et al. discloses microencapsulated particles with outer walls including water-soluble polymers or polymer mixtures (see col. 6 line 47—col. 8, line 6) as well as enzymes. U.S. Pat. No. 7,294,678 to McGlothlin et al. shows a polynitrile oxide or polynitrile oxide dispersion microencapsulated within a barrier material coating prior to compounding it into a rubber mixture to prevent premature reaction with rubber particles. U.S. Pat. No. 7,368,613 to Eh teaches microencapsulation using capsule materials made of wax-like plastics materials such as polyvinyl alcohol, polyurethane-like substances, or soft gelatin. The disclosures of the foregoing patents are hereby incorporated by reference. Still further information is found in U.S. Pat. No. 4,889,877 to Seitz and U.S. Pat. No. 4,936,916 to Shinmitsu et al. and U.S. Pat. No. 5,741,592 to Lewis et al. relating to microencapsulation, the disclosures of which are also incorporated herein by reference.

The microencapsulated adhesive composition is applied in the form of a liquid dispersion, preferably an aqueous dispersion which is immobilized on the substrate in a non-adhesive state prior to cup forming as described hereinafter. The dispersion may include binders, such as starch, polyvinyl alcohol, methoxycellulose, hydroxyethylcellulose, carboxymethylcellulose, polyvinyl pyrrolidone, polyacrylamide, polyacrylic acid, gelatin and so forth. Carriers other than water may be used if compatible with the other components. The dispersion may include unencapsulated components of the adhesive compositions as well as thickeners and so forth, if so desired.

The application rate of the microencapsulated adhesive (dry basis) may be from 0.25 to 10 pounds per 3000 ft², suitably from about 0.5 or 1 to 5 lbs for 3000 ft², such as 2-3 pounds per 3000 ft². The adhesive may be applied by any suitable means known in the art. For example, flexographic printing or any other suitable coating method may be employed.

The microencapsulated adhesive composition may be activated by pressure, temperature, or perhaps radiation, ultrasonic treatment, solvents such as water, and combinations thereof Preferably, activation is done by pressure and water, thereby breaking the microcapsules and activating a dry adhesive therein, or by increasing temperature, particularly in use with a low-activation temperature (e.g., 150° F.) hot-melt adhesive. Adhesives having activation temperatures in the range of 150° F. to 250° F. may be used if so desired. The amount of pressure required to rupture the microcapsules varies with the size of the capsule and the thickness of the capsule wall. The pressure required to rupture the microcapsules and release the activating agent may range from about 0.5 psi to about 200 psi. Suitable pressures required to rupture the shell of the microcapsules may be more preferably ranging from about 30 psi to about 70 psi. Temperature-activated adhesive may be activated by heat from the mandrel which may operate at temperatures of 200-300° F. and above. Once sufficient pressure or heat has been applied, the microcapsules release their contents, activating the adhesive system to seal the seam.

In one embodiment, a hot melt adhesive, immobilized on the web and without a microencapsulated feature may be used. Examples of hot melt adhesives include at least one thermoplastic polymer and at least one additional thermoplastic ingredient selected from tackifying resins, plasticizers, waxes, and mixtures thereof. See, U.S. Pat. No. 6,084,010 to Baetzold et al, Col. 4.

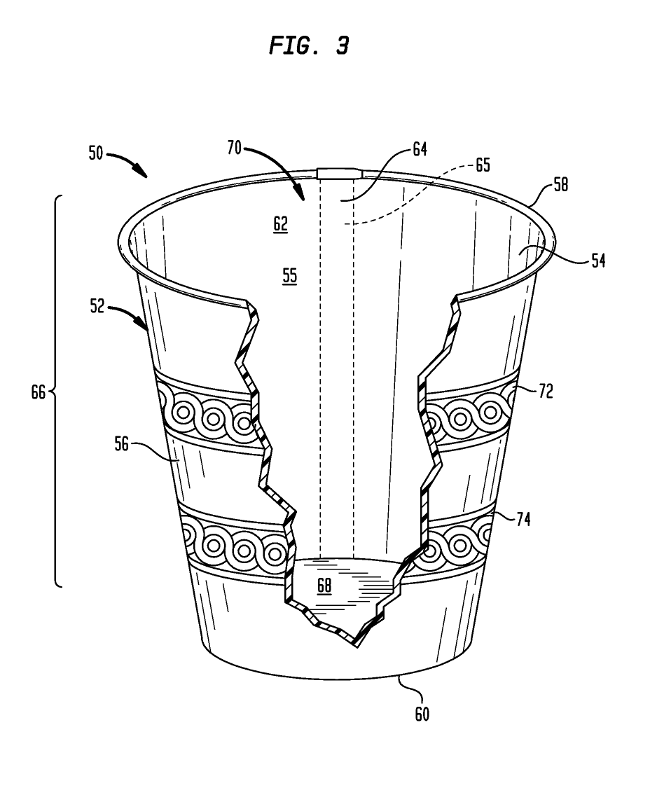

Referring to FIG. 3, there is shown a disposable paper cup 50 including a sidewall 52 with inner and outer surfaces 54, 56, an upper brim 58 and a lower portion 60 formed from a paperboard blank 62. The sidewall has a sidewall seam 64 extending over a seal length 66 from brim 58 to lower portion 60, that is, over the entire height of the cup. It is appreciated from the diagram and the discussion which follows that sidewall 52 is formed from a paperboard blank having an interior portion corresponding to surface 54 of the sidewall of the cup and a seam portion corresponding to sidewall seam 64. Seam 64 of cup 50 is secured by a microencapsulated adhesive 65 applied to the seam portion of the paperboard blank which is subsequently pressed to rupture the microcapsules of the adhesive so as to activate the adhesive when forming the seam of the cup, the adhered seam thus includes residue of the microcapsule walls of the microencapsulated adhesive as well as the released adhesive component within. There is also a cup bottom panel 68 secured to the sidewall such that the sidewall and optional bottom panel define a container volume 70.

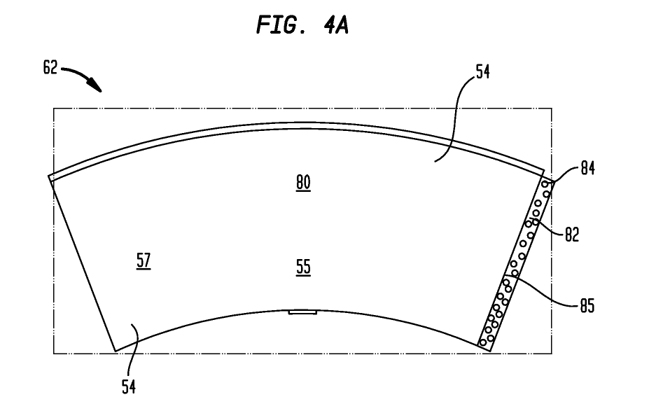

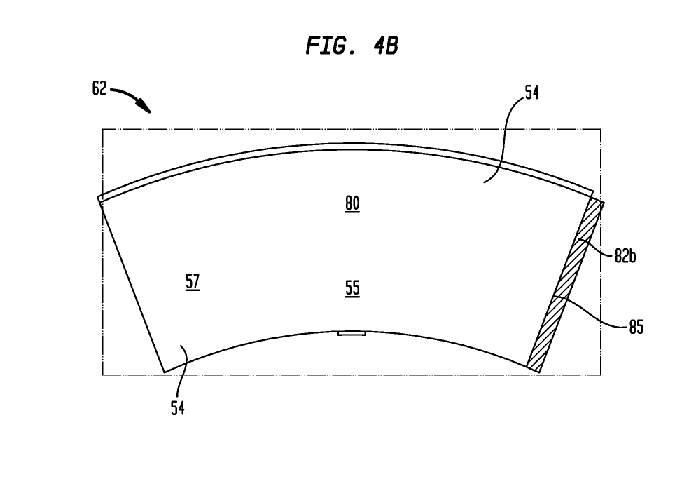

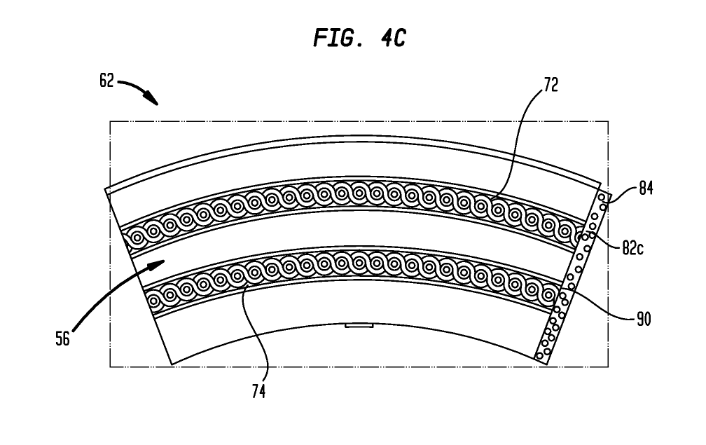

In one embodiment, the microencapsulated adhesive is selected and applied such that the seam forms a substantially continuous and liquid proof seal over the seal length of the sidewall seam of the cup and inner surface 54 having a wax coating 57. See FIG. 4A. The microencapsulated adhesive is juxtaposed with the wax coating on the interior portion of the paperboard blank, and the cup is formed such that the wax coating is substantially contiguous with microencapsulated adhesive over the entire seal length 66 of the sidewall seam when the seam is formed. As shown, outer surface 56 of the sidewall is provided with printed decorative patterns 72, 74 which were applied to the paperboard concurrently with the microencapsulated adhesive in common registry therewith, that is when the paperboard web was fixed in a coating/printing line. Cup 50 may have any suitable container volume 70 typically from 1 fluid ounce to 16 fluid ounces, such as a container volume of from 3 fluid ounces to 7 fluid ounces, most typically from 3 fluid ounces to 5 fluid ounces.

Referring now to FIGS. 3 and 4A, a paperboard blank 62 for forming sidewall 52 of paper cup 50 including a paperboard substrate 80 having an interior portion 55 corresponding to the inner surface 54 of the sidewall of the formed cup and a seam portion 82 corresponding to sidewall seam 64. Seam portion 82 of the blank is provided with a rupturable, microencapsulated adhesive composition 84 which is immobilized on the blank by a binder or the like in a non-adhesive state suitable for securing the sidewall seam upon rupture of microcapsules of the composition, by pressure, pressure and solvent, heat or any suitable activating means. The application of adhesive coating 84 on seam portion 82 extends from the edge of wax coating 57 along wax line 85 to the edge of the blank. The wax/adhesive pattern shown in FIG. 4A is printed on a board web as a repeating pattern in a printing/coating line as is described hereinafter.

Interior surface portion 55 of the paperboard blank has a wax coating 57 thereon. It will be appreciated from FIGS. 3 and 4A that microencapsulated adhesive 84 is applied to the seam portion of the paperboard blank such that the microencapsulated adhesive is juxtaposed with wax coating 57 on the interior portion of the paperboard blank, such that the wax coating is substantially contiguous with microencapsulated adhesive over the seal length of the sidewall seam when the cup is formed. Generally, the microencapsulated adhesive has a microcapsule size of from 2 microns to 200 microns; such as a microcapsule size of from 5 microns to 100 microns or a microcapsule size of from 5 microns to 20 microns and suitably having an average diameter of about 10 microns in some preferred embodiments. Adhesive composition 84 may include a water-soluble glue including polyvinyl acetate adhesive or adhesive 84 may include a solvent borne adhesive such as a water-insoluble acrylate adhesive. So also, the microencapsulated adhesive may include a water-soluble adhesive and a water-insoluble adhesive. Alternatively, the microencapsulated adhesive may include a hot-melt adhesive and/or adhesive 84 comprises a plurality of microspheres of different composition or a pressure and solvent sensitive system as described herein.

Referring to FIGS. 3, 4B and 4C, there is illustrated another embodiment of the present invention. FIG. 4B is a plan view of the inside, or interior surface 54 of a paperboard blank for forming cup 50. Interior surface 54 has a wax coating 57 which extends to wax line 85 of an overlap sealing area 82b. Area 82b is uncoated paperboard.

FIG. 4C is a plan view of the outer surface 56 of the paperboard blank of FIG. 4B. The cup forming blank has pained decorative patterns 72, 74 and seam portion 82c is provided with microencapsulated adhesive 84.

The microencapsulated adhesive 84 may be applied as an aqueous dispersion using multiple application layers. To this end, a plurality of ink printing decks may be used while concurrently printing patterns 72, 74 on the outside of the cup blank stock as shown. The aqueous dispersion may be anywhere from about 15% to 50% by weight solids and may be applied to paperboard at add-on rates of from 0.25 to 10 pounds per 3000 ft² as noted above, with from 0.5 or 1 to 5 pounds per 3000 ft² being typical and 2-3 lbs per 3000 ft² being a preferred amount. The aqueous dispersion employed may typically be from 20%-40% (W/W) solids or perhaps more preferably 25% to 30%. Multiple coatings (2-3 applications) may be used to achieve the aforementioned add-on rates if so desired, with perhaps 2-3 coats being preferred. The microencapsulated adhesive extends to a borderline 90.

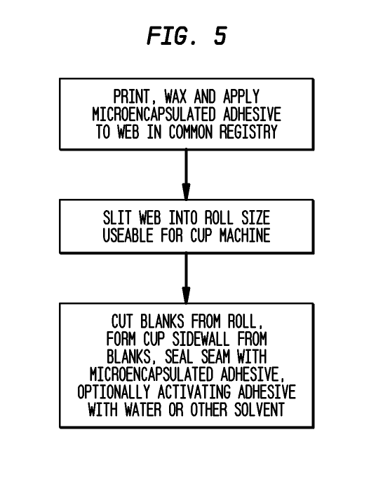

Referring to FIG. 5, there is provided a process flow diagram illustrating manufacture of paper cups in accordance with this invention. In a first step, a web is waxed, printed and provided with microencapsulated adhesive on a single coating line in common registry; that is, all 3 operations are carried out when the paperboard is fixed on the same production line. Next, the web or board is slit and made into rolls of useable size for a conventional cup machine. These rolls are then fed to a cup machine where the roll is unwound, blanked and formed into cup sidewalls.

With respect to the embodiment illustrated in connection with FIGS. 3, 4B and 4C, a pressure and solvent-(water) sensitive microencapsulated adhesive, as described above, is used on outer side 56 of the paperboard blank. Prior to forming the sidewall seam of the cup, overlap sealing area 82B is wetted with water. Area 82B is placed in contact with area 82C when the cup is formed. A clamp (not shown) presses the sealing areas together and ruptures the microencapsulated adhesive which was previously applied to area 82C. Water, which was applied to area 82B, activates the encapsulated adhesive after the membranes of the microcapsules are ruptured and a seal is formed over length 66 (FIG. 3).

The construction illustrated in FIGS. 3, 4B and 4C is readily adapted to existing cup machines when using pressure and solvent-sensitive adhesive inasmuch as the otherwise idle glue feed system can be used to provide solvent to sealing area 82b. So also, the process of preparing the sheet stock for blanking is readily adapted to existing pring lines inasmuch as an aqueous dispersion of microencapsulated adhesive can be applied concurrently with a printed pattern on the outside side of the sheet using otherwise idle flexographic printing decks, for example.

A preferred forming process thus includes the sequential steps of providing a paperboard blank as shown in FIGS. 4B and 4C to a conventional cup-forming machine, wetting area 82b with water using vestigial glue application equipment, overlapping area 82b with area 82c and pressing in order to seal the seam. The method of the invention is particularly effective in that gaps in glue application, especially in critical areas of the seam where it meets a bottom panel are avoided.

In this regard, one of skill in the art will appreciate that it is impractical to apply liquid glue to the edge of a blank with a round glue wheel because the forming machine will become fouled by glue since the wheel will tend to overshoot the edge of the blank unless some degree of tolerance is provided. Thus there is typically a small unglued gap which occurs at the most likely spot of cup adhesion failure—where the sidewall seam meets the bottom of the cup and there are at least 3 layers, and in some designs, five layers of paperboard. With the invention, this problem is avoided since the glue is printed in place with precision before the blank is even cut.

There is thus provided in a first Embodiment of the invention a paperboard blank for forming a sidewall of a paper cup comprising a paperboard substrate having an interior portion corresponding to the inner surface of the sidewall of the formed cup and a seam portion corresponding to a sidewall seam area of the formed cup, wherein the seam portion of the blank is provided with a rupturable, microencapsulated adhesive composition in a non-adhesive state suitable for securing the sidewall seam upon rupture of microcapsules of the composition and activation of the adhesive.

Embodiment No. 2 is a paperboard blank of the first embodiment wherein the microencapsulated adhesive composition is a pressure and solvent-sensitive adhesive composition.

Embodiment No. 3 is any of the foregoing embodiments of the invention, wherein further, the adhesive composition is a water-sensitive adhesive composition.

Embodiment No. 4 is any of the foregoing embodiments of the invention, wherein further, the interior portion of the paperboard blank has a wax coating.

Embodiment No. 5 is any of the foregoing embodiments of the invention, wherein further, the microencapsulated adhesive is applied to the seam portion of the paperboard blank such that the microencapsulated adhesive is juxtaposed with the wax coating on the interior portion of the paperboard blank, such that the wax coating is substantially contiguous with microencapsulated adhesive over the seal length of the sidewall seam when the cup is formed.

Embodiment No. 6 is any of the foregoing embodiments of the invention, wherein further, the microencapsulated adhesive has a microcapsule size of from 2 microns to 200 microns.

Embodiment No. 7 is any of the foregoing embodiments of the invention, wherein further, the microencapsulated adhesive has a microcapsule size of from 5 microns to 100 microns.

Embodiment No. 8 is any of the foregoing embodiments of the invention, wherein further, the microencapsulated adhesive has a microcapsule size of from 5 microns to 20 microns.

Embodiment No. 9 is any of the foregoing embodiments of the invention, wherein further, the microencapsulated adhesive comprises an encapsulated water-soluble glue.

Embodiment No. 10 is any of the foregoing embodiments of the invention, wherein further, the water-soluble glue comprises polyvinyl acetate adhesive.

Embodiment No. 11 is any of the foregoing embodiments of the invention, wherein further, the microencapsulated adhesive comprises a water-insoluble adhesive.

Embodiment No. 12 is any of the foregoing embodiments of the invention, wherein further, the microencapsulated adhesive comprises a water-insoluble acrylate adhesive.

Embodiment No. 13 is any of the foregoing embodiments of the invention, wherein further, the microencapsulated adhesive comprises a water-soluble adhesive and a water-insoluble adhesive.

Embodiment No. 14 is any of the foregoing embodiments of the invention, wherein further, the microencapsulated adhesive comprises a hot-melt adhesive.

Embodiment No. 15 is any of the foregoing embodiments of the invention, wherein further, the microencapsulated adhesive comprises a plurality of microspheres of different composition.

Embodiment No. 16 of the invention is a method of making paperboard blanks suitable for forming into sidewalls of disposable paper cups comprising: (a) supplying a paperboard web to a coating line; (b) coating the web in the coating line with a liquid-resistant coating in a first predetermined pattern on a first side thereof corresponding to interior surfaces of sidewalls of paperboard cups formed from the paperboard blanks; (c) coating the web in the coating line with a microencapsulated adhesive in a second predetermined pattern corresponding to seam areas of paperboard cups formed from the paperboard blanks, the microencapsulated adhesive thereby being applied in common registry with the liquid-resistant coating in the coating line; and (d) cutting paperboard blanks from the web. The process of this embodiment may employ paperboard blanks having any of the features of Embodiments Nos. 1-15 as well.

Embodiment No. 17 includes the feature of Embodiment 16 and further includes of the invention is winding the web into a roll and removing the web from the coating line, followed by unwinding the roll prior to cutting the paperboard blanks therefrom.

Embodiment No. 18 of the invention includes the features of Embodiment Nos. 16 or 17 and further wherein the web is printed in the coating line on a second side thereof with a decorative pattern, the pattern thereby being applied in common registry with the liquid resistant coating and the microencapsulated adhesive in the coating line.

Embodiment No. 19 of the invention includes the features of Embodiment Nos. 16, 17 or 18 and further wherein there is provided in the coating line on the second side thereof a second decorative pattern, the second decorative pattern thereby being applied in common registry with the first decorative pattern, the liquid resistant coating and the microencapsulated adhesive in the coating line.

Embodiment No. 20 of the invention is a method of making a paper cup comprising: (a) providing a paperboard blank for a sidewall of the paper cup including a paperboard substrate having an interior portion corresponding to the inner surface of the sidewall of the cup and a first seam portion corresponding to a sidewall seam area of the formed cup, wherein the seam portion of the blank is provided with a rupturable, microencapsulated adhesive composition in a non-adhesive state suitable for securing the sidewall seam upon rupture of microcapsules of the composition and activation of the adhesive; (b) forming the paperboard blank into the sidewall of the cup; and (c) rupturing microcapsules of the microencapsulated adhesive composition. The process of this Embodiment may include any of the features described in connection with Embodiments Nos. 1-19 noted above.

Embodiment No. 21 of the invention further includes rupturing the microcapsules by application of pressure as well as all of the other aspects of Embodiment No. 20.

Embodiment No. 22 of the invention includes rupturing the microcapsules by application of heat as well as the other aspects of Embodiment No. 20.

Embodiment No. 23 includes the features of Embodiment No. 20, wherein the rupturable, microencapsulated adhesive composition comprises a pressure and solvent-sensitive microencapsulated adhesive composition.

Embodiment No. 24 includes the features of Embodiment No. 20, wherein the microencapsulate adhesive composition is a water-sensitive adhesive composition.

Embodiment No. 25 includes the features of Embodiment No. 20, wherein the blank has a second seam portion corresponding to the sidewall seam area of the formed cup for adhering to the first seam portion and wherein the process further comprises wetting the second seam portion.

Embodiment No. 26 of the invention is a method of manufacturing a paper cup comprising; (a) providing a paperboard sidewall blank having an interior portion corresponding to an inner surface of the cup and a sidewall seam portion provided with an activatable adhesive in a non-adhesive state; (b) forming the paperboard sidewall blank into the sidewall of a cup having a sidewall seam over a seal length which extends substantially over the entire length of the cup; and (c) activating the adhesive to secure the sidewall seam of the cup. The paperboard blank may have any of the features of Embodiment Nos. 1-15.

Embodiment No. 27 of the invention includes the features of Embodiment No. 27, wherein the activatable adhesive is selected from rupturable microencapsulated adhesives and hot melt adhesives having a melting temperature greater than 75° C.

Embodiment No. 28 of the invention includes the features of Embodiment No. 27, wherein the activatable adhesive is a microencapsulated adhesive.

Embodiment No. 29 of the invention is a disposable paper cup comprising: (a) a sidewall with inner and outer surfaces, an upper brim and a lower portion formed from a paperboard blank, the sidewall having a sidewall seam extending over a seal length from the brim to the lower portion of the cup, (i) the paperboard blank having an interior portion corresponding to the inner surface of the sidewall of the cup and a seam portion corresponding to the sidewall seam of the cup, (ii) the seam of the cup being secured by a microencapsulated adhesive applied to the seam portion of the paperboard blank which is subsequently pressed to release the adhesive when forming the seam of the cup, the adhered seam thus including residue of the microcapsule walls of the microencapsulated adhesive as well as the released adhesive within; and (b) an optional cup bottom panel secured to the sidewall such that the sidewall and optional bottom panel define a container volume. Any of the features of Embodiments Nos. 1-28 may be utilized in connection with the manufacture of the cup of this Embodiment.

Embodiment No. 30 of the invention includes the features of Embodiment No. 29, wherein the microencapsulated adhesive is selected and applied such that the seam forms a substantially continuous and liquid proof seal over the seal length of the sidewall seam of the cup.

Embodiment No. 31 of the invention includes the features of Embodiment No. 29, wherein the interior portion of the paperboard blank has a wax coating.

Embodiment No. 32 of the invention includes the features of Embodiment No. 29, wherein the microencapsulated adhesive is applied to the seam portion of the paperboard blank such that the microencapsulated adhesive is juxtaposed with the wax coating on the interior portion of the paperboard blank, and the cup is formed such that the wax coating is substantially contiguous with the microencapsulated adhesive over the entire seal length of the sidewall seam when the seam is formed.

Embodiment No. 33 of the invention includes the features of Embodiment No. 29, wherein the outer surface of the sidewall is provided with a printed decorative pattern applied to the outside of the paperboard blank concurrently with the microencapsulated adhesive in common registry therewith.

Embodiment No. 34 of the invention includes the features of Embodiment No. 29, wherein the microencapsulated adhesive is applied to the seam portion of the paperboard blank such that the microencapsulated adhesive is juxtaposed with the printed pattern on the outside of the paperboard blank.

Embodiment No. 35 of the invention includes the features of Embodiment No. 29, wherein the cup has the bottom panel and a container volume of from 3 fluid ounces to 5 fluid ounces.

Embodiments 36-40 below may additionally include any of the features or combinations of Embodiments 1-35.

Embodiment No. 36 is a method of making a paper cup comprising providing a paperboard blank for the sidewall of the paper cup having a central portion and a first and second seam portion at opposite edges of the paperboard blank an on opposite sides thereof, at least one of the seam portions having immobilized thereon a pressure and solvent-sensitive microencapsulated adhesive in a non-adhesive state; applying an activating solvent to at least one of the seam portions; forming the paperboard blank into a sidewall of a cup including overlapping the first and second seam portions to form a sidewall seam; (d) applying pressure to the seam in order to rupture microcapsules of the microencapsulated adhesive and activate the adhesive whereby the adhesive contacts the solvent and adheres the first and second seam portions to one another.

Embodiment No. 37 is a method according to Embodiment 36 wherein the microencapsulated adhesive composition is a pressure and water-sensitive adhesive composition.

Embodiment No. 38 is a method according to Embodiment 36 wherein the pressure and solvent-sensitive adhesive composition is applied to one seam portion of the paperboard blank and the other seam portion is wetted with solvent.

Embodiment No. 39 is a method according to Embodiment 36 wherein the first seam portion is on an exterior side of the paperboard blank and is provided with an immobilized pressure and solvent-sensitive adhesive in a non-adhesive state and the second seam portion is on an interior side of the paperboard blank and the method includes applying solvent to the second seam portion.

Embodiment No. 40 is a method according to Embodiment 36 wherein the pressure and solvent-sensitive microencapsulated adhesive composition comprises polyvinyl acetate.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A paperboard blank for forming a sidewall of a paper cup comprising a paperboard substrate having an interior portion corresponding to the inner surface of the sidewall of the formed cup and a seam portion corresponding to a sidewall seam area of the formed cup, wherein the seam portion of the blank is provided with a rupturable, microencapsulated adhesive composition in a non-adhesive state suitable for securing the sidewall seam upon rupture of microcapsules of the composition and activation of the adhesive.

2. The paperboard blank according to claim 1, wherein the microencapsulated adhesive composition is a pressure and solvent-sensitive adhesive composition.

3. The paperboard blank according to claim 2, wherein the adhesive composition is a pressure and water-sensitive adhesive composition.

4. The paperboard blank according to claim 1, wherein the interior portion of the paperboard blank has a wax coating.

5. The paperboard blank according to claim 4, wherein the microencapsulated adhesive is applied to the seam portion of the paperboard blank such that the microencapsulated adhesive is juxtaposed with the wax coating on the interior portion of the paperboard blank, such that the wax coating is substantially contiguous with microencapsulated adhesive over the seal length of the sidewall seam when the cup is formed.

6. The paperboard blank according to claim 1, wherein the microencapsulated adhesive has a microcapsule size of from 2 microns to 200 microns.

7. The paperboard blank according to claim 1, wherein the microencapsulated adhesive has a microcapsule size of from 5 microns to 100 microns.

8. The paperboard blank according to claim 1, wherein the microencapsulated adhesive has a microcapsule size of from 5 microns to 20 microns.

9. The paperboard blank according to claim 1, wherein the microencapsulated adhesive comprises an encapsulated water-soluble glue.

10. The paperboard blank according to claim 9, wherein the water-soluble glue comprises polyvinyl acetate adhesive.

11. The paperboard blank according to claim 1, wherein the microencapsulated adhesive comprises a water-insoluble adhesive.

12. The paperboard blank according to claim 1, wherein the microencapsulated adhesive comprises a water-insoluble acrylate adhesive.

13. The paperboard blank according to claim 1, wherein the microencapsulated adhesive comprises a water-soluble adhesive and a water-insoluble adhesive.

14. The paperboard blank according to claim 1, wherein the microencapsulated adhesive comprises a hot-melt adhesive.

15. The paperboard blank according to claim 1, wherein the microencapsulated adhesive comprises a plurality of microspheres of different composition.

16. A disposable paper cup comprising:
(a) a sidewall with inner and outer surfaces, an upper brim and a lower portion formed from a paperboard blank, the sidewall having a sidewall seam extending over a seal length from the brim to the lower portion of the cup,
(i) the paperboard blank having an interior portion corresponding to the inner surface of the sidewall of the cup and a seam portion corresponding to the sidewall seam of the cup,
(ii) the seam of the cup being secured by a microencapsulated adhesive applied to the seam portion of the paperboard blank which is subsequently pressed to release the adhesive when forming the seam of the cup, the adhered seam thus including residue of the microcapsule walls of the microencapsulated adhesive as well as the released adhesive within; and
(b) an optional cup bottom panel secured to the sidewall such that the sidewall and optional bottom panel define a container volume.

17. The disposable paper cup according to claim 16, wherein the microencapsulated adhesive is selected and applied such that the seam forms a substantially continuous and liquid proof seal over the seal length of the sidewall seam of the cup.

18. The disposable paper cup according to claim 16, wherein the interior portion of the paperboard blank has a wax coating.

19. The disposable paper cup according to claim 18, wherein the microencapsulated adhesive is applied to the seam portion of the paperboard blank such that the microencapsulated adhesive is juxtaposed with the wax coating on the interior portion of the paperboard blank, and the cup is formed such that the wax coating is substantially contiguous with the microencapsulated adhesive over the entire seal length of the sidewall seam when the seam is formed.

20. The disposable paper cup according to claim 16, wherein the outer surface of the sidewall is provided with a printed decorative pattern applied to the outside of the paperboard blank concurrently with the microencapsulated adhesive in common registry therewith.

21. The disposable paper cup according to claim 20, wherein the microencapsulated adhesive is applied to the seam portion of the paperboard blank such that the microencapsulated adhesive is juxtaposed with the printed pattern on the outside of the paperboard blank.

22. The disposable paper cup according to claim 16, wherein the cup has the bottom panel and a container volume of from 3 fluid ounces to 5 fluid ounces.
